(19) United States
(12) Patent Application Publication
(10) Pub. No.: US 2007/0039043 A1
(43) Pub. Date: Feb. 15, 2007

(54) Distributed global log off for a single sign-on account

(75) Inventor: Robert Garskof, Northford, CT (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/201,864

(22) Filed: Aug. 11, 2005

(51) Int. Cl. G06F 17/30

(52) U.S. Cl. 726/8

(57) ABSTRACT

The present invention provides a method and apparatus for logging off of a global session and releasing resources from applications associated with the global session. When a user logs off of a single sign on (SSO) global session a Distributed Global Logoff Manager tracks each SSO family member application and any other application to which a user has logged on during the global session, and simulates the user logging off from each individual application to which the user ends the global SSO session. Distributed Global Logoff allows each application in a SSO family to participate in the logoff so that each application can free its resources immediately rather than waiting for a session time out to release application resources. Resources allocated to various applications such as data base connections, programs stored in memory and transactional data stored in memory are released.

### BACKGROUND OF THE INVENTION

1. Field of the Invention

The present invention relates to logging off of multiple applications and releasing resources in a communication network.

2. Description of the Related Art

With the growth of the Internet and the proliferation of services that are provided over the Internet, end-users, such as web users and web customers, have begun to accumulate multiple usernames and passwords for authenticating their access to these many services. Along with the proliferation of usernames and passwords comes the problem of keeping track of them. If a given service is used infrequently, the associated username and password can slip from memory. On the other hand, the tendency of end-users to keep a written record lying around on a desk or computer monitor leaves one open to the possibility of password misuse and associated breaches in security. Single Sign On (SSO) has been introduced so that a user can sign on to multiple applications using a single password.

Prior to SSO, applications managed their own logon and logoff they created and maintained their own session locally in their application. Applications attached resources to their session and when a user performed a logoff those resources were freed allowing them to be used by another user. In an SSO scenario a global concept of session is created that is managed across all applications that share that sign on. Each individual application still maintains its own session and its own resources, but it links them to the global session that the SSO tooling maintains.

When a user logs on they are given a global session. As that user moves from one application to another each application creates its own local session as needed. Hence after a user consumes say five applications, there is one global session and 5 local sessions active. Logoff now becomes a problem. Before SSO, when a user signed off they only needed to clean up the session (and hence release the resources) associated with that one application. SSO uses the logoff to the global session but does not clean up the sessions in progress with the local applications at each site. As a result the addition of SSO causes extra resource consumption on each of the applications that participate in the SSO family. That is resources are tied up unnecessarily. This becomes a significant problem in a corporation with thousands of employees who each use and log off of ten to twenty or more applications daily. Each application requires resources to be allocated for each session. In this scenario, the cumulative delay in releasing resources for each application in after a session ends represents a substantial impact on available resources. The cumulative delay may cause unnecessary expenditure on equipment when demand is falsely inflated by tying up resources after a user has logged off from an application.

### SUMMARY OF THE INVENTION

The present invention provides a method and apparatus for logging off of a global session and releasing resources from applications logged onto in the global session. When a user logs off of a SSO global session a Distributed Global Logoff Manager (DLOM) tracks each SSO family member application and any other application to which a user has logged on during the global session, and simulates the user logging off from each individual application to which the user ends the global SSO session. Distributed Global Logoff allows each application in a SSO family to participate in the logoff so that each application can free its resources immediately rather than waiting for a session time out to release application resources. Resources allocated to various applications such as data base connections, programs stored in memory and transactional data stored in memory are released. As a result each application can free resources to process transactions from new users. This allows service to more users with fewer resources than would other wise be possible, saving the money in hardware and bandwidth. Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 is a context diagram for a local session in a prior art system;

FIG. 2 is a sequence diagram for a local log off in a prior art system;

FIG. 3 is a context diagram for a global session in a prior art system;

FIG. 4 is a sequence diagram for a global log off in a prior art system;

FIG. 5 is a context diagram for a global distributed logout in an example of the present invention;

FIG. 6 is a sequence diagram for a global distributed logout in an example of the present invention; and

FIG. 7 is an example of a data structure for a global distributed logout in an example of the present invention.

### DETAILED DESCRIPTION OF THE INVENTION

In view of the above, the present invention through one or more of its various aspects and/or embodiments is presented to provide one or more advantages, such as those noted below.

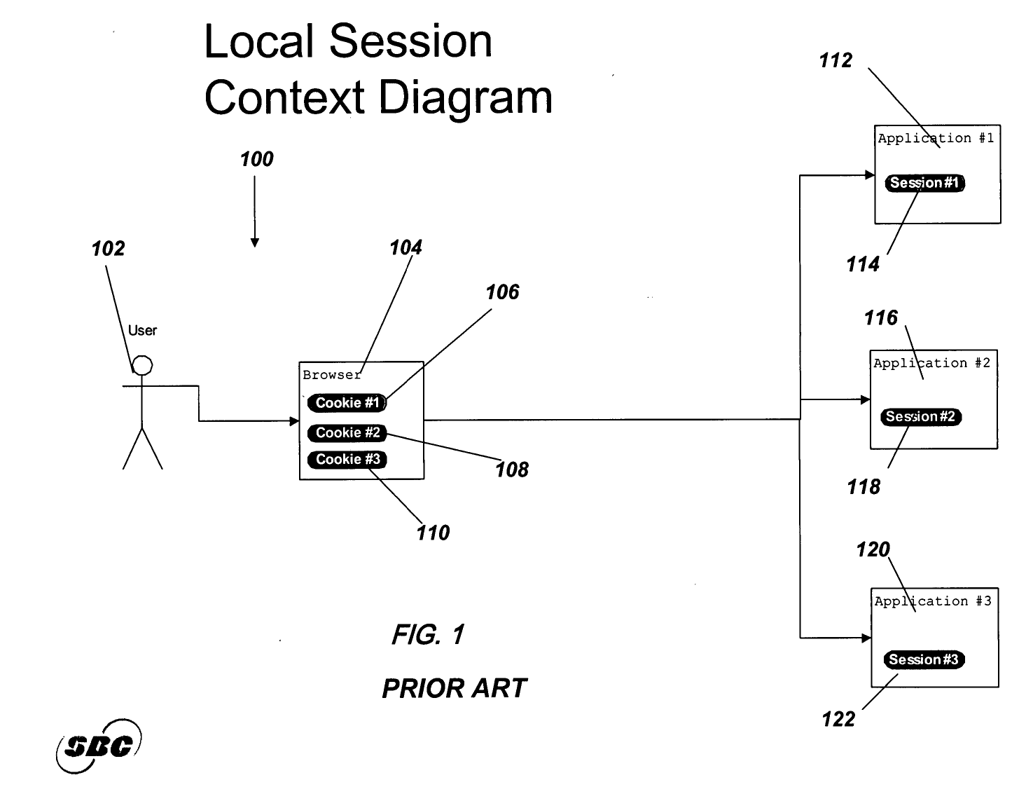

Turning now to FIG. 1, an illustration of local session context diagram 100 for a prior art system. As shown in FIG. 1 in the prior art a user at terminal 102 uses a browser 104 to log onto applications. In the present example of FIG. 1 the user logs onto application 1 112, application 2 116 and application 3 120. At each application a session is established between the user and the application. A session 114 is established between user 102 and application 1 112. A session 118 is established between user 102 and application 2 118. A session 122 is established between user terminal 102 and application 3 120. For session 114 a cookie 106 is placed on the browser 104. For session 118 a cookie 108 is placed on the browser 104. For session 122 a cookie 110 is placed on the browser 104.

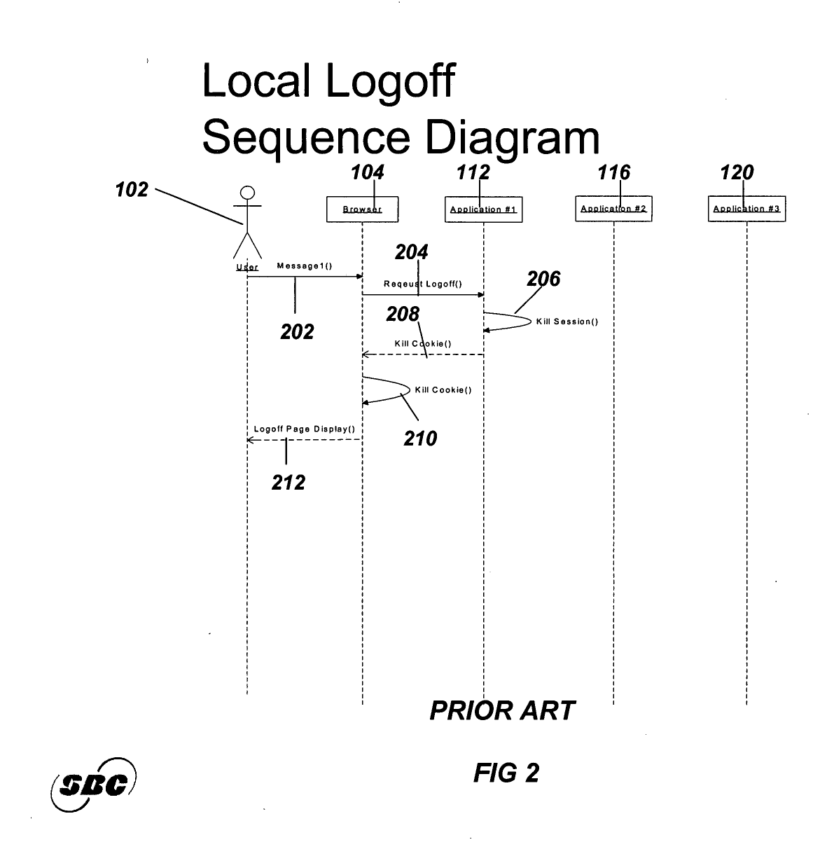

Turning now to FIG. 2, a prior art local logoff sequence diagram 200 is illustrated. The user at terminal 102 sends a log off message 202 to the browser 104. The browser then sends a logoff request 204 to application 1 112. Application 112 then kills 204 the session 114. Application 1 sends a kill cookie message 208 to browser 104. Browser 104 then kills 210 cookie 106 associated with the session with application 1 112. The browser 104 then displays a logoff page 212 to the user at terminal 102. A similar local log off sequence is performed between the user and application 2 116 and application 3 120.

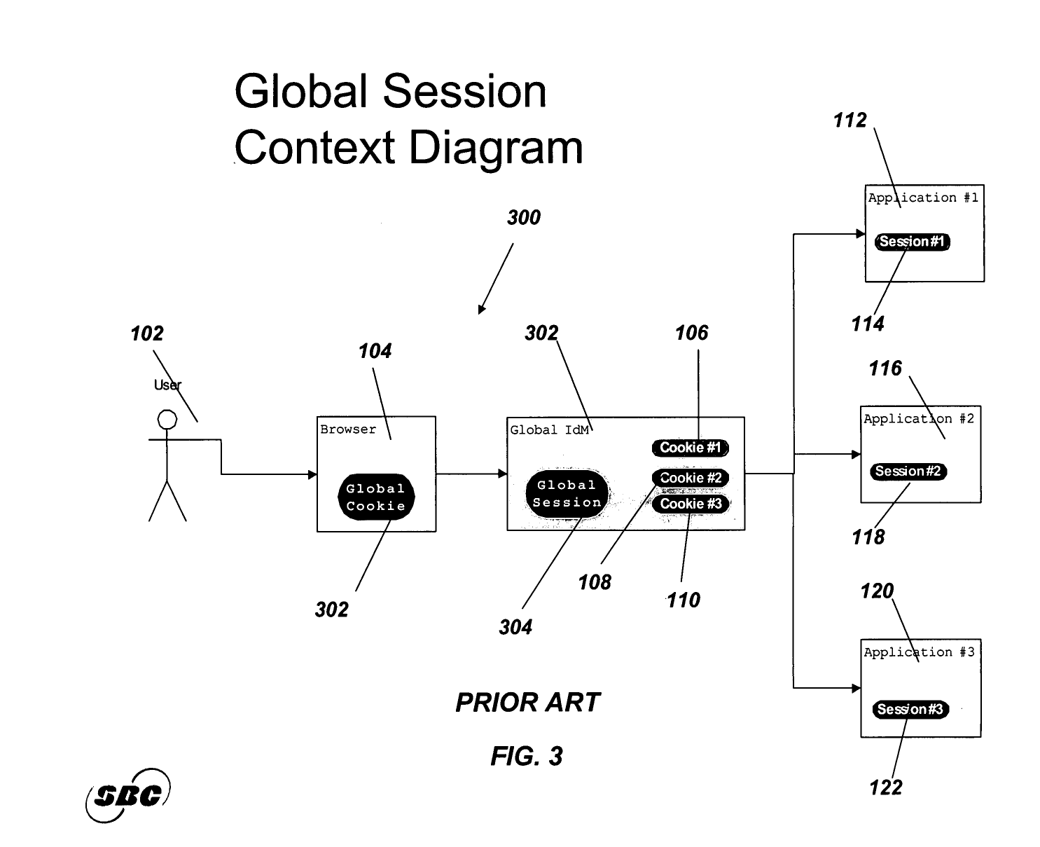

Turning now to FIG. 3, a prior art global session context diagram is illustrated. In a global session the user at terminal 102 uses browser 104 to sign on to application 1 114, application 2 116 and application 3 120. A global cookie 302 is placed on browser 104. A global session 304 is established for the user at the global identity manager 302. Cookies 106, 108 and 110 are established for session 1 114 with application 1 112, session 2 118 with application 2 116 and session 3 122 with application 3 120.

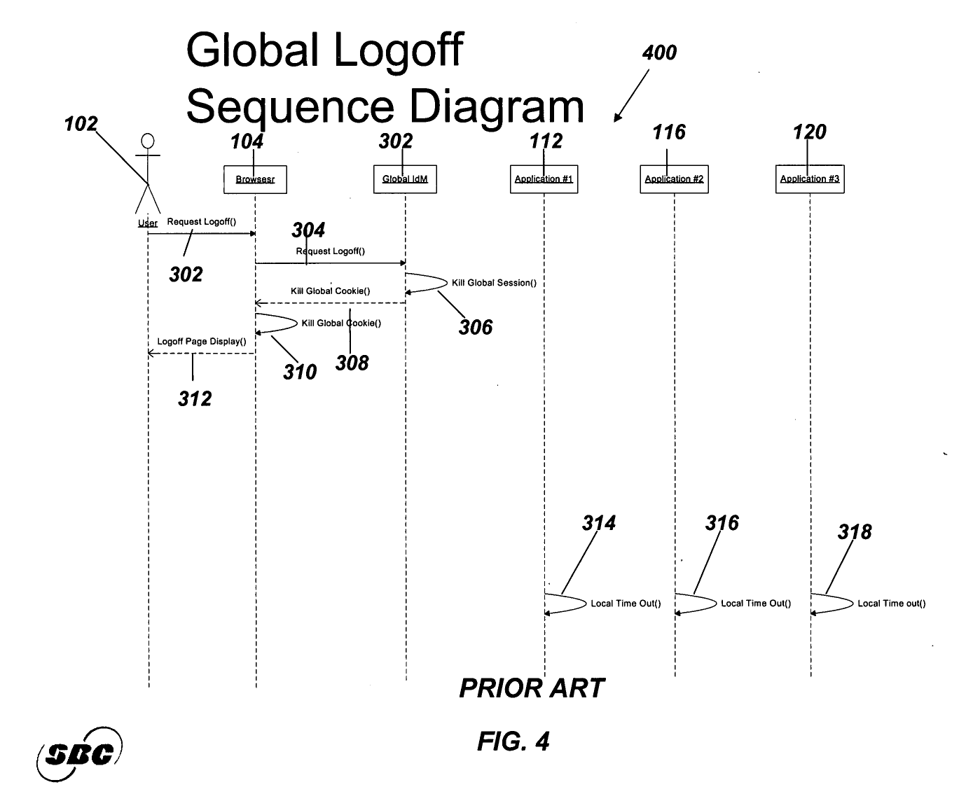

Turning now to FIG. 4, a prior art global log off sequence diagram 400 is illustrated. As shown in FIG. 4, a user sends a request to log off 302 from the global session to browser 104 from terminal 102. Browser 104 sends a global log off request 304 to the global identity manager 302. The global identify manager then kills 306 the global session. The global identity manager 302 then sends a kill global cookie message 308 to browser 104. Browser 104 then kills the global cookie 310 and displays the global log off page 312 to the user at terminal 102. The applications (112, 116 and 120) are not notified of the global log off and are left to time out locally. Thus application 1 112 is subject to local time out 314, application 2 116 is subject to local time out 316 and application 3 120 is subject to local time out 318. Each local timeout can last up to 12-24 hours, thus leaving resources dedicated to applications 1, 2 and 3 tied up and unavailable until the associated time out occurs.

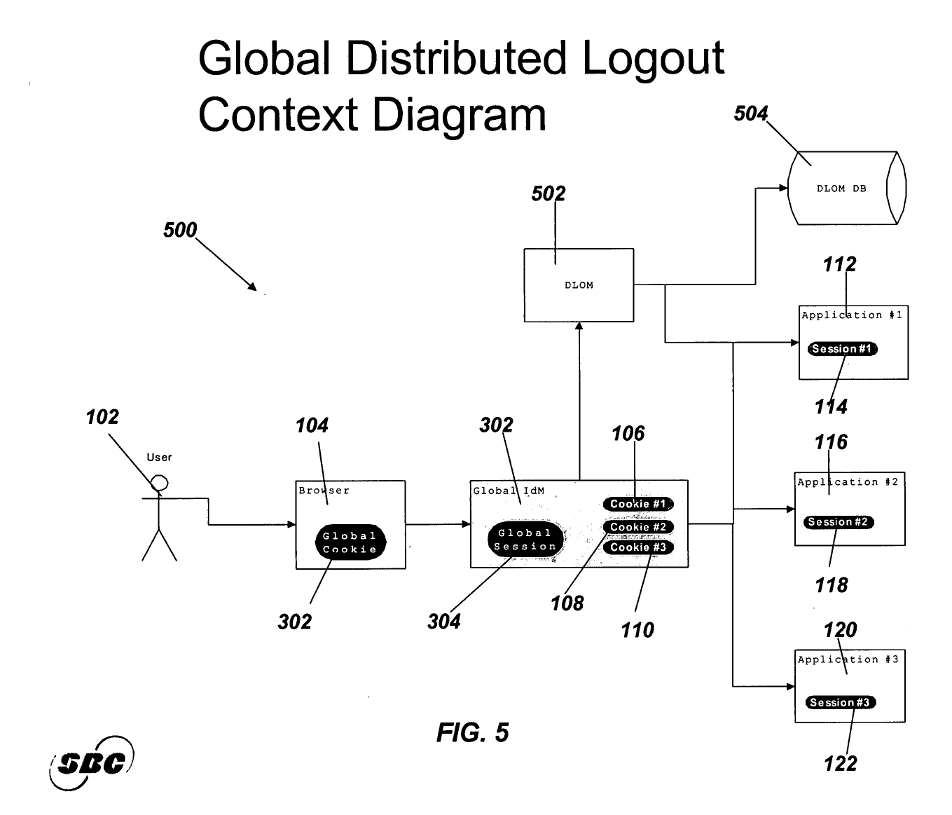

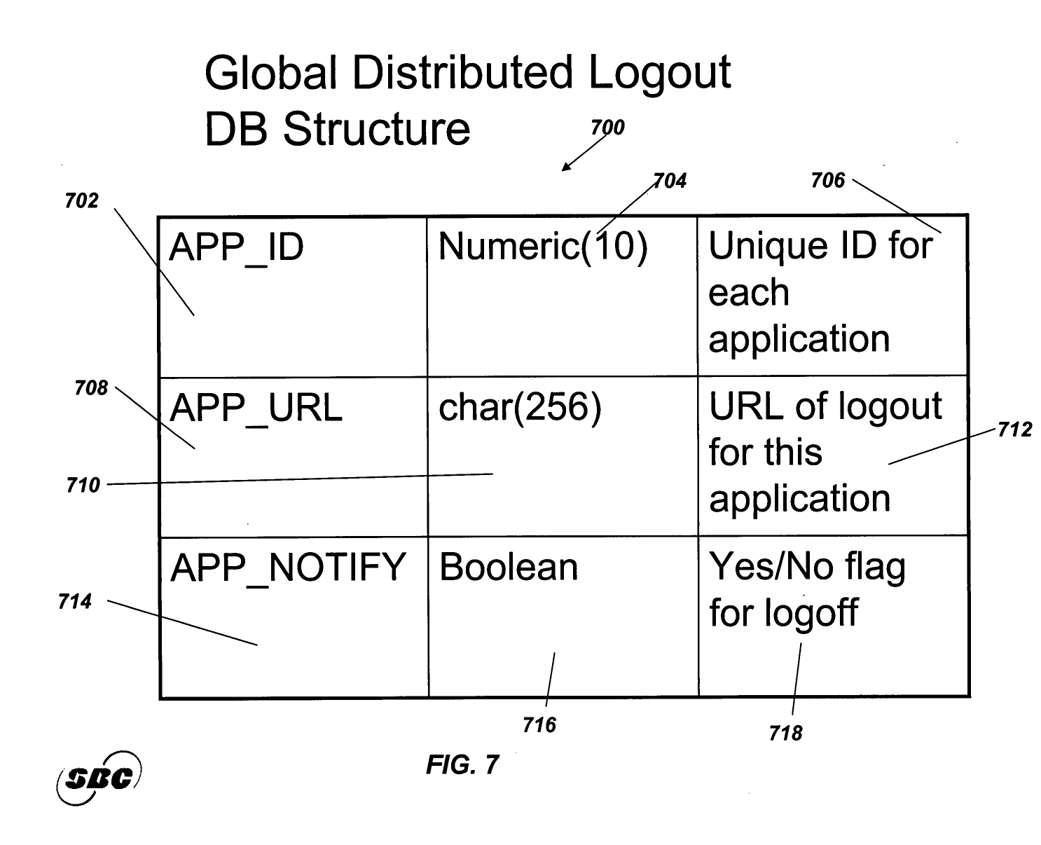

Turning now to FIG. 5, an example of the present invention is presented in which a global distributed logout is provided. FIG. 5 is an illustration of a context diagram 500 for global distributed logout. As shown in FIG. 5, the user at terminal 102 signs on to browser 104 processor which places a global cookie 302 on the browser. A global session 304 is established between the browser 104 and the global identity manager 302 processor. As the user logs onto applications 1, 2 and 3, messages are sent to distributed log off manager (DLOM) 502 processor which keeps track of applications onto which the user logs on. As the user logs on to each application, the DLOM keeps track of the applications in the DLOM data base 504. Information as to how to log off of each application to which the user has logged on is kept in the DLOM DB. An example of information which can be kept in the DLOM DB 504 is shown in FIG. 7, discussed below. In one embodiment the DLOM processor is an IBM IAX platform and the DLOM DB is an Oracle DB running on an IBM AIX platform. The applications and Identity Manager can be any processor platform such as IBM, Macintosh or Linux, for example.

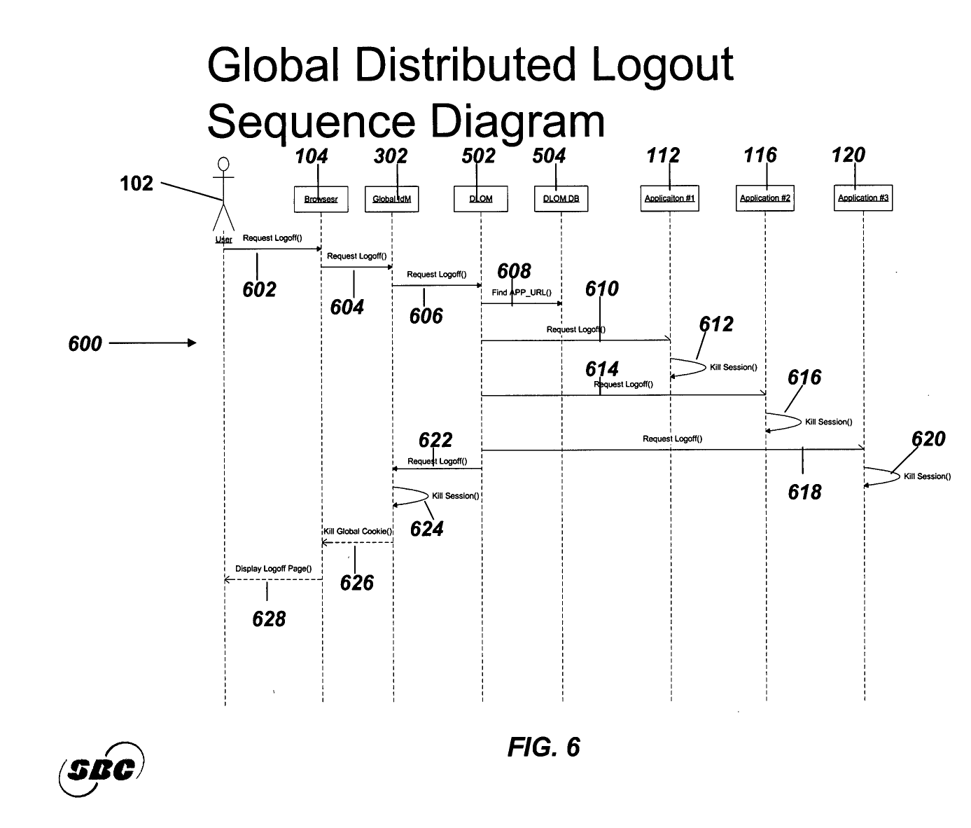

Turning now to FIG. 6, a global distributed logout sequence diagram 600 is illustrated. As shown in FIG. 6, a user at terminal 102 sends a logout request 602 to browser 104. Browser 104 sends logout request 604 to the global identity manager 302. The global identity manager 302 sends a logout request 606 to the DLOM 502. DLOM sends a request to the DLOM DB 608 (Find APP_URL) to retrieve log out information for the application to which the user is logged on. In this case the user is logged on to application 1, 2 and 3. The DLOM retrieves log off information for application 1, 2 and 3. The DLOM sends a log off request 610 to application 1. Application I kills 612 the session with the user and releases the resources associated with the session between the user and application 1. The DLOM sends a log off request 614 to application 2. Application 2 kills 616 the session with the user and releases the resources associated with the session between the user and application 2. The DLOM sends a log off request 618 to application 3. Application 1 kills 620 the session with the user and releases the resources associated with the session between the user and application 3. The DLOM then sends a log off request 622 to the global identity manager 302. The global identity manager then kills 624 the global session 304 and sends a kill global cookie 626 message to the browser 104. The browser then displays a log off page 628 to the user at terminal 102.

Turning now to FIG. 7, an illustration of global distributed logout database structure 700 is illustrated. As shown in FIG. 7 for each application an application identifier (APP_ID) 702, application uniform resource locator (APP_URL) 708 and application notification message 714 are provided. Other messages and data can be provided in the DLOM DB and are not limited to those provided in the example presented herein. The application identifier 702 may comprise a 10-digit number 704 and unique identifier 706 assigned in the DLOM DB for each application. The application uniform resource locator 708 may comprise a character string 710 of 256 characters and a uniform resource locator (URL) 712 for logout for the application. The application notification 714 may comprise a Boolean field 716 and a yes/no flag 718 for activating or deactivating the logoff function of the DLOM.

In an alternative embodiment as shown in FIG. 8, the DLOM is located between the user terminal 102 and the Identity Manager. In this case the user logs onto the DLOM using a SSO login. The DLOM receives the SSO log in and logs the user on to the identity manager. DLOM also handles signing on and logging off of applications, which includes releasing resources associated with the applications as shown in FIG. 9.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computerized method for terminating a global session comprising:
establishing a global session between a user and at least one application;
accessing log off information for the at least one application;
logging off of the at least one application using the log off information; and
terminating the global session.

2. The method of claim 1, wherein establishing the global session further comprises establishing a session with an identity manager.

3. The method of claim 1, wherein the global session is a single sign on session.

4. The method of claim 1, wherein the application is associated with a member of a single sign on family.

5. The method of claim 1, wherein the log off information is obtained from the at least one application.

6. The method of claim 1, wherein the log off information is stored in a data base.

7. The method of claim 1, further comprising:
releasing resources associated with the application.

8. A computer readable medium containing instructions that when executed by a computer perform a computerized method for terminating a global session comprising:
establishing a global session between a user and at least one application;
accessing log off information for the at least one application;
logging off of the at least one application using the log off information; and
terminating the global session.

9. The medium of claim 8, wherein the method further comprises establishing the global session further comprises establishing a session with an identity manager.

10. The medium of claim 8, wherein in the method the global session is a single sign on session.

11. The medium of claim 10, wherein in the method the application is a member of a single sign on family.

12. The medium of claim 8, wherein in the method the log off information is obtained from the at least one application.

13. The medium of claim 8, wherein in the method the log off information is stored in a data base.

14. The medium of claim 8, the method further comprising:
releasing resources associated with the application.

15. A set of application program interfaces embodied on a computer readable medium for execution on a computer in conjunction with an application program that terminates a global session and releases resources allocated to the global session, comprising:
a first interface that receives an input for establishing a global session for a user;
a second interface receives an input for establishing a session with an application for the global session; and
a third interface that receives an input for releasing a resource allocated to the application and terminating the global session.

16. The set of application program interfaces of claim 15 further comprising:
a fourth interface for receiving application log off information for releasing the resource.

17. The set of application program interfaces of claim 16 wherein the log off information is stored on a data base.

18. A computer readable medium having stored thereon a data structure comprising:
a first field containing data representing an application identifier; and
a second field containing data representing log off information for the application identified by the application identifier.

19. The computer readable medium of claim 18 wherein the log off information is a uniform resource locator for logout for the application identified by the application identifier.

20. The computer readable medium of claim 18 wherein the application is associated with a member of a single sign on family.
